(19) United States
(12) Patent Application Publication
(10) Pub. No.: US 2025/0271040 A1
(43) Pub. Date: Aug. 28, 2025

(54) DISK AND METHOD FOR MANUFACTURING THE SAME

(71) Applicants: Hyundai Motor Company, Seoul (KR); Kia Corporation, Seoul (KR)

(72) Inventors: Jung Ro YOON, Hwaseong-Si (KR); Sung Hyun Cho, Hwaseong-Si (KR); Jeong Kyu Kim, Hwaseong-Si (KR)

(73) Assignees: Hyundai Motor Company, Seoul (KR); Kia Corporation, Seoul (KR)

(21) Appl. No.: 18/798,741

(22) Filed: Aug. 8, 2024

(30) Foreign Application Priority Data
Feb. 22, 2024 (KR) 10-2024-0025888

(51) Int. Cl. F16D 65/00; F16D 55/225; F16D 65/02; F16D 65/12

(52) U.S. Cl. CPC F16D 65/0006; F16D 65/128; F16D 55/225; F16D 2065/1308; F16D 2065/132; F16D 2200/0056

(57) ABSTRACT

A brake disk includes a first surface including a first brake surface-contacting with a brake pad, a second surface including a second brake surface, a circumferential portion connecting the first surface and the second surface, and at least one of at least one first internal groove formed on the first surface, at least one second internal groove formed on the second surface, or at least one external groove formed in the circumferential portion, or any combination thereof, the at least one first internal groove includes a shape, in which the first surface is recessed in a direction facing the second surface, the at least one second internal groove includes a shape, in which the second surface is recessed in a direction facing the first surface, and the at least one external groove includes a shape, in which the circumferential portion is recessed in a direction facing a rotation axis of the brake disk.

### CROSS-REFERENCE TO RELATED APPLICATION

The present application claims priority to Korean Patent Application No. 10-2024-0025888, filed on Feb. 22, 2024, the entire contents of which is incorporated herein for all purposes by this reference.

### BACKGROUND OF THE PRESENT DISCLOSURE

### Field of the Present Disclosure

The present disclosure relates to a disk and a method for manufacturing the same, and more particularly, to a technology for restraining reflected waves of a disk.

### Description of Related art

A braking system of a vehicle is a device that performs braking by converting rotational kinetic energy of wheels into thermal energy through friction between a brake disk and a pad. Accordingly, a resonance occurs in the braking system due to the exciting energy between the brake disk and the pad, and when the resonance exceeds a damping limit of the system, noise may be generated.

Here, when the noise falls within a frequency range of 1 to 16 kHz, it is squeal noise, and the sound is unpleasant, which has become a major complaint among users. However, even though the squeal noise of the braking device is designed to be prevented during a mobility development stage, wear occurs on the disks and pads included in the braking device over time, and vibration features of the braking device also change, and thus, noise that has not occurred may occur.

To solve these problems, it is necessary to develop a technology for reducing braking frictional noise by forming grooves on the disk to restrain reflected waves generated during braking.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a brake disk that provides a brake disk including an internal groove formed on a surface including a brake surface and an external groove formed on a circumferential portion, and reduces development costs of the brake disk through an operation of avoiding frequencies between portions included in the brake disk and adding a damping member for reducing amplitudes to the brake disk, by providing the brake disk with the grooves each including a curve corresponding to a power function, and a method for manufacturing the same.

An aspect of the present disclosure also provides a brake disk which may restrain squeal noise and reflected waves of the brake disk by providing the brake disk that includes a groove formed as a curve based on a first function for restraining the reflected waves of the brake disk and a second function for cooling the brake disk, and a method for manufacturing the same.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a brake disk includes a first surface including a first brake surface-contacting with a brake pad, a second surface including a second brake surface, a circumferential portion connecting the first surface and the second surface, and at least one of at least one first internal groove formed on the first surface, at least one second internal groove formed on the second surface, or at least one external groove formed in the circumferential portion, or any combination thereof, the at least one first internal groove includes a shape, in which the first surface is recessed in a direction facing the second surface, the at least one second internal groove includes a shape, in which the second surface is recessed in a direction facing the first surface, and the at least one external groove includes a shape, in which the circumferential portion is recessed in a direction facing a rotation axis of the brake disk.

In an exemplary embodiment of the present disclosure, each of the first internal groove, the second internal groove, and the at least one external groove may include at least one of a first curve corresponding a predetermined function, a second curve being different from the first curve, or a straight line, or any combination thereof.

In an exemplary embodiment of the present disclosure, the first curve may be determined based on a first function for restraining a reflected wave in the brake disk.

In an exemplary embodiment of the present disclosure, the first curve may be determined based on a second function for cooling the brake disk.

In an exemplary embodiment of the present disclosure, the first internal groove may include a first symmetrical shape symmetrical with respect to an imaginary first plane passing through a lower end portion of the first internal groove and being perpendicular to the first surface, and the second internal groove may include a second symmetrical shape symmetrical with respect to an imaginary second plane passing through a lower end portion of the second internal groove and being perpendicular to the second surface.

In an exemplary embodiment of the present disclosure, the imaginary first plane passing through the lower end portion of the first internal groove and being perpendicular to the first surface and the imaginary second plane passing through the lower end portion of the second internal groove and being perpendicular to the second plate may be a same or different.

In an exemplary embodiment of the present disclosure, the first internal groove may include a first asymmetrical shape symmetrical with respect to an imaginary plane passing through a lower end portion of the first internal groove and being perpendicular to the first surface, and the second internal groove may include a second asymmetrical shape symmetrical with respect to an imaginary plane passing through a lower end portion of the second internal groove and being perpendicular to the second surface.

In an exemplary embodiment of the present disclosure, at least one of the first asymmetrical shape or the second asymmetrical shape, or any combination thereof may include at least two curves determined based on a first function for restraining a reflected wave in the brake disk.

In an exemplary embodiment of the present disclosure, at least one of the first asymmetrical shape or the second asymmetrical shape, or any combination thereof may include at least two curves determined based on a second function for cooling the brake disk.

In an exemplary embodiment of the present disclosure, the recessed shape of the at least one external groove may include at least two curves determined based on a first function for restraining a reflected wave in the brake disk.

In an exemplary embodiment of the present disclosure, the recessed shape of the at least one external groove may include at least two curves determined based on a second function for cooling the brake disk.

In an exemplary embodiment of the present disclosure, the circumferential portion may include at least one of a first external groove recessed in a direction facing the first internal groove or a second external groove recessed in a direction facing the second internal groove, or any combination thereof.

In an exemplary embodiment of the present disclosure, the circumferential portion may include a first point commonly included by the first external groove and the first surface, and a second point commonly included by the second external groove and the second surface, and a first distance from the first point to the rotation axis and a second distance from the second point to the rotation axis may be a same or different.

In an exemplary embodiment of the present disclosure, all or some of at least one of the recessed shape of the first internal groove, the recessed shape of the second internal groove, or the recessed shape of the at least one external groove, or any combination thereof may include a viscoelastic layer.

In an exemplary embodiment of the present disclosure, the viscoelastic layer may include at least one of any one of a viscoelastic layer formed of rubber or a viscoelastic layer formed of polyurethane, or any combination thereof.

In an exemplary embodiment of the present disclosure, the viscoelastic layer formed of the rubber may include a layer including adhesive, rubber, and metal.

In an exemplary embodiment of the present disclosure, the viscoelastic layer formed of the polyurethane may include a layer including adhesive, polyurethane, and nanoclay.

In an exemplary embodiment of the present disclosure, the circumferential portion may include a plurality of passages arranged in a same direction as a circumferential direction of the circumferential portion, and through which air for cooling the brake disk passes.

In an exemplary embodiment of the present disclosure, the brake pad may include a pad located based on a first reference distance being a distance from the rotation axis to an outskirt point of the circumferential portion, a second reference distance being a distance from the rotation axis to the first point or the second point, and a third reference distance being a distance from the rotation axis to an outskirt point of one of the at least one first internal groove, which is adjacent to one of at least one external groove, and the first internal groove may include an internal groove located between the third reference distance and a fourth reference distance being a distance from the rotation axis to a start point of the external portion.

In an exemplary embodiment of the present disclosure, an interval between one of the at least one first internal groove, which is adjacent to the brake pad, and the brake pad may include a fifth reference distance.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a perspective view exemplarily illustrating a brake disk according to an exemplary embodiment of the present disclosure;

FIG. 2 is a cross-sectional view exemplarily illustrating a brake disk according to an exemplary embodiment of the present disclosure;

FIG. 3 is a cross-sectional view exemplarily illustrating a brake disk including a plurality of internal grooves in the brake disk according to an exemplary embodiment of the present disclosure;

FIG. 4 is a cross-sectional view exemplarily illustrating a brake disk coupled to a plurality of internal grooves and a brake pad in the brake disk according to an exemplary embodiment of the present disclosure;

FIG. 5 is a cross-sectional view exemplarily illustrating a brake disk including an internal groove including an asymmetrical shape in the brake disk according to an exemplary embodiment of the present disclosure;

FIG. 6 is a view exemplarily illustrating an internal groove in a brake disk according to an exemplary embodiment of the present disclosure;

FIG. 7 is a view exemplarily illustrating a recessed shape of an internal groove in a brake disk according to an exemplary embodiment of the present disclosure;

FIG. 8 is a view exemplarily illustrating an external groove in a brake disk according to an exemplary embodiment of the present disclosure;

FIG. 9 is a view exemplarily illustrating formation positions of an internal groove and an external groove in a brake disk according to an exemplary embodiment of the present disclosure;

FIG. 10 is a view exemplarily illustrating a ventilated disk in a brake disk according to an exemplary embodiment of the present disclosure; and

FIG. 11 is a perspective view exemplarily illustrating a brake disk coupled to a caliper and a knuckle in the brake disk according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the accompanying drawings. In adding reference numerals to the components of the drawings, it is noted that the same components are denoted by the same reference numerals even when they are drawn in different drawings. Furthermore, in describing the exemplary embodiments of the present disclosure, when it is determined that a detailed description of related known configurations and functions may hinder understanding of the exemplary embodiments of the present disclosure, a detailed description thereof will be omitted. Various embodiments of the present disclosure will be described with reference to the accompanying drawings. However, this is not intended to limit the technology described in an exemplary embodiment of the present disclosure to specific embodiments, and should be understood to include various modifications, equivalents, and/or alternatives to the exemplary embodiments of the present disclosure. In relation to the description of the drawings, similar reference numbers may be used for similar components.

Furthermore, in describing the components of the exemplary embodiments of the present disclosure, terms, such as first, second, “A”, “B”, (a), and (b) may be used. The terms are simply for distinguishing the components, and the essence, the sequence, and the order of the corresponding components are not limited by the terms. Unless otherwise defined, all terms, including technical and scientific terms, used herein include the same meaning as commonly understood by those skilled in the art to which the present disclosure pertains. It will be further understood that terms, such as those defined in commonly used dictionaries, should be interpreted as having a meaning which is consistent with their meaning in the context of the specification and relevant art and should not be interpreted in an idealized or overly formal sense unless so defined herein. For example, expressions, such as “first” or “second,” which are used in an exemplary embodiment of the present disclosure may represent various elements regardless of any order and/or importance, and are only used to distinguish one component from another component and does not limit the components. For example, a first component may be renamed a second component without departing from the scope of rights described in an exemplary embodiment of the present disclosure, and similarly, the second component may be renamed to the first component.

In an exemplary embodiment of the present disclosure, expressions, such as “have,” “may have,” “includes,” or “may include” refer to the relevant features (e.g., components, such as values, functions, operations, or parts) and do not exclude the presence of additional features.

When it is mentioned that a component (e.g., a first component) is “(operatively or communicatively) coupled with/to” another component (e.g., a second component), it should be understood that any of the components may be directly connected to the other components or may be connected through another component (e.g., a third component). On the other hand, when it is mentioned that a component (e.g., a first component) is “directly connected” or “directly electrically connected” to another component (e.g., a second component), It may be understood that no other component (e.g., a third component) exists between other components.

The expressions “configured to” used in an exemplary embodiment of the present disclosure, for example, may be replaced with “suitable for,” “having the capacity to,” and “designed to”, “designed to,” “adapted to,” “made to,” or “capable of” according to situations.

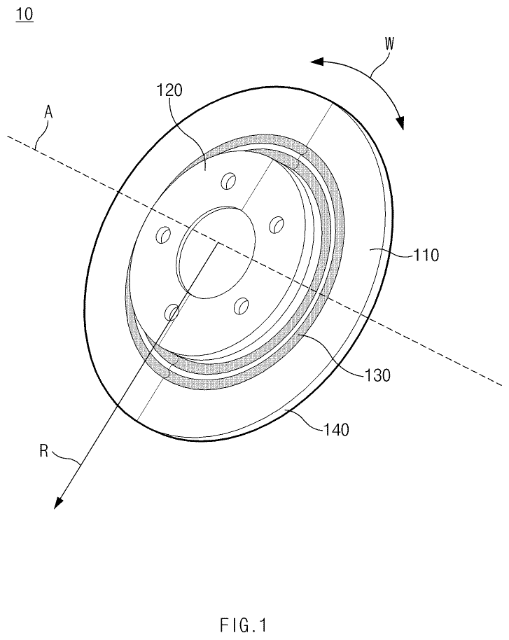

FIG. 1 is a perspective view exemplarily illustrating a brake disk according to an exemplary embodiment of the present disclosure.

A brake disk 10 according to various exemplary embodiments of the present disclosure may be a component which may be included in various mobility. In particular, as will be described later, the brake disk 10 may perform a rotation about a rotation axis “A” when the mobility is moved on a ground. For example, the brake disk 10 may include an external portion 110 and an internal portion 120 with respect to the rotation axis “A”.

The internal portion 120 may include a fastening surface which may contact wheels and a fastening surface which may contact with a hub. For example, the internal portion 120 may be fixedly coupled to the external portion 110.

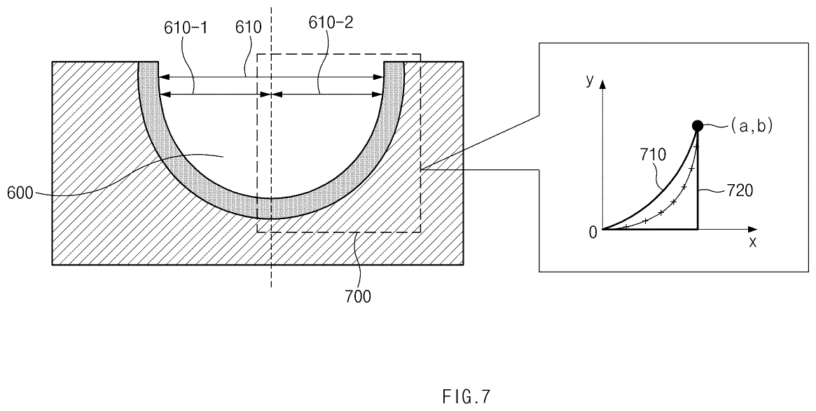

The external portion 110 may include a frictional surface which may contact with a brake pad. For example, the external portion 110 may include an internal groove 130 and an external groove 140. The internal groove 130 may include at least one of a first curve corresponding to a predetermined function, a second curve which is different from the first curve, or a straight line, or any combination thereof. The external groove 140 may include at least one of a first curve, a second curve, or a straight line, or any combination thereof. For example, the brake disk 10 may reduce squeal noise which may occur when the brake pad contacts with the external portion 110, through the internal groove 130 and the external groove 140. In other words, the brake disk 10 may reduce squeal noise which may occur when the brake pad contacts with the external portion 110, through the internal groove 130 and the external groove 140 including at least one of a first curve, a second curve, or a straight line, or any combination thereof. A detailed description of the first curve and the second curve will be described later in FIG. 7 below.

For example, a radial direction “R” of the brake disk 10 and a circumferential direction “W” of the external portion 110 will be described based on a state, in which the brake disk 10 includes a shape which is similar to that of a general disk.

The brake disk 10 may include a first surface including a first brake surface that contacts with the brake pad, a second surface including a second brake surface that contacts with the brake pad, and a circumferential portion that connects the first surface and the second surface.

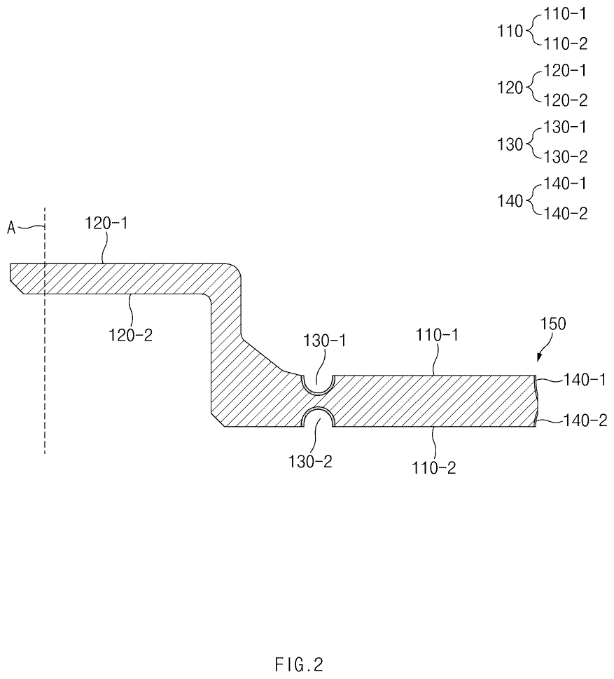

FIG. 2 is a cross-sectional view exemplarily illustrating the brake disk according to an exemplary embodiment of the present disclosure.

The brake disk 10 according to various exemplary embodiments of the present disclosure may include an external portion 110 and an internal portion 120. In example, the internal portion 120 may include a first fastening surface 120-1 which may contact with the wheel, and a second fastening surface 120-2 which may contact with a hub. The external portion 110 may include at least one frictional surface which may contact with the brake pad. The external portion 110 may include a first surface 110-1 including a first brake surface that contacts with the brake pad, a second surface 110-2 including a second brake surface that contacts with the brake pad, and a circumferential portion 150 that connects the first surface 110-1 and the second surface 110-2.

The external portion 110 may include an internal groove 130 and an external groove 140. In detail, the external portion 110 may include at least one of at least one first internal groove 130-1 which is formed on the first surface 110-1, at least one second internal groove 130-2 which is formed on the second surface 110-2, or a first external groove 140-1 and a second external groove 140-2 that are formed in the circumferential portion 150 of the brake disk 10, or any combination of these.

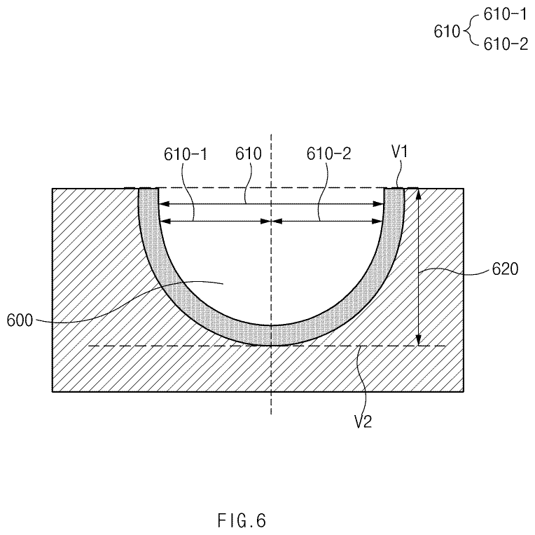

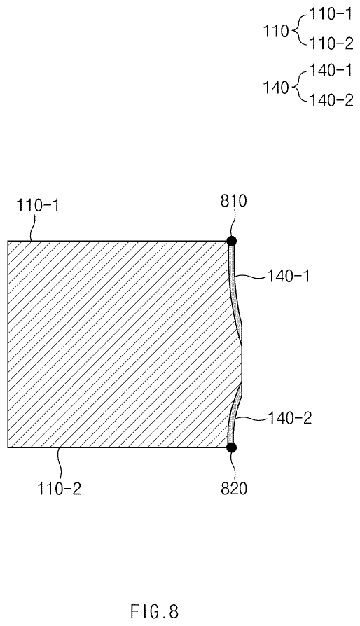

The first internal groove 130-1 may include a shape, in which the first surface 110-1 is recessed in a direction that faces the second surface 110-2. The second internal groove 130-2 may include a shape, in which the second surface 110-2 is recessed in a direction that faces the first surface 110-1. A detailed description of the first internal groove 130-1 and the second internal groove 130-2 will be made in FIG. 6 and FIG. 7 below. The external groove 140 may include a shape, in which the circumferential portion 150 of the brake disk 10 is recessed in a direction that faces a rotation axis “A” of the brake disk 10. In detail, the external groove 140 may include a first external groove 140-1 and a second external groove 140-2, and each of the external grooves may include a groove that includes a set length along the circumferential portion 150 of the brake disk 10 and forms a curvature. For example, at least one external groove may be provided along the circumferential portion 150 of the brake disk 10. A detailed description of the first external groove 140-1 and the second external groove 140-2 will be made later in FIG. 8 below.

The first internal groove 130-1 may include a first symmetrical shape that passes through a lower end portion of the first internal groove 130-1 and which is symmetrical with respect to an imaginary first plane which is perpendicular to the first surface 110-1. The second internal groove 130-2 may include a second symmetrical shape that passes through a lower end portion of the second internal groove 130-2 and which is symmetrical with respect to an imaginary second plane which is perpendicular to the second surface 110-2.

The circumferential portion 150 of the brake disk 10 may include a first external groove 140-1 which is recessed in a direction that faces the first internal groove 130-1, or a second external groove 140-2 which is recessed in a direction that faces the second internal groove 130-2, or at least one of any combination thereof.

A reflective wave restraining effect of the grooves (e.g., the first internal groove 130-1, the second internal groove 130-2, the first external groove 140-1, and the second external groove 140-2 included in the brake disk 10 may be described by use of Equations 1 to 3 below.

$$k = {( \frac{3 {ρω}^{2}}{{E}_{pl} {a}^{2}} )}^{1 / 4} \cdot \frac{1}{{x}^{n / 2}} \qquad [ Equation 1 ]$$

Here, axⁿ may mean a shape or a profile of a groove that follows a power function, ρ may mean a density of a disk, on which a groove is formed, and Eₚₗ may mean the Young's modulus of the disk, on which the groove is formed, ω may mean an angular frequency of a bending wave, and k may mean the number of bending waves of a groove.

$${c}_{gr} = \frac{\partial ω}{\partial k} = 2 {{a}^{1 / 2} ( \frac{{E}_{pl} {ω}^{2}}{3 ρ} )}^{1 / 4} \cdot {x}^{n / 2} \qquad [ Equation 2 ]$$

Here, c_{gr} may mean a value obtained by differentiating the angular frequency (ω)) of the bending wave by the number (k) of the bending waves. In other words, Equation 2 may mean that as the number of the bending waves of the groove increases, a speed of the waves which may be transmitted in the groove may decrease.

$$T = {\int }_{{x}_{0}}^{{x}_{1}} \frac{dx}{{c}_{gr}} = \frac{1}{2 {a}^{1 / 2}} {( \frac{3 ρ}{{E}_{pl} {ω}^{2}} )}^{1 / 4} \cdot {\int }_{{x}_{0}}^{{x}_{1}} {x}^{- n / 2} dx \qquad [ Equation 3 ]$$

Here, “T” may mean a travel time of the wave which is a value obtained by differentiating a travel distance x of the wave which may be transmitted in the groove by the speed of the wave, from a position x0 to a position x1. In other words, Equation 3 may include a meaning that the travel time of the wave increases as the speed of the wave decreases compared to the same travel distance, and a wave delay phenomenon of the wave may be described through Equation 3. A detailed description of the reflected wave restraining effect of the grooves included (e.g., the first internal groove 130-1, the second internal groove 130-2, the first external groove 140-1, and the second external groove 140-2 in the brake disk 10) will be made in FIG. 7 below.

All or some of at least one of the recessed shape of the first internal groove 130-1, the recessed shape of the second internal groove 130-2, or the recessed shape of the external groove 140, or any combination thereof may include a viscoelastic layer. For example, the viscoelastic layer may include at least one of a viscoelastic layer formed of rubber, or a viscoelastic layer formed of polyurethane, or any combination thereof. In detail, the viscoelastic layer formed of the rubber may be a viscoelastic layer including an adhesive-rubber-metal layer. The viscoelastic layer formed of the polyurethane may be a viscoelastic layer including an adhesive-polyurethane-nanoclay layer. The viscoelastic layer may be disposed at a position which is spaced from the rotation axis “A” at a predetermined distance.

The brake disk 10 may include a viscoelastic layer in the recessed shape of at least one groove to achieve the following effects. For example, a speed of a wave which is transmitted in the groove may be reduced and a transmission time thereof may be delayed compared to a wave which is transmitted in a straight line rather than in a groove. That is, the brake disk 10 may delay the transmission time of a wave which is generated by friction between the external portion 110 and the brake pad, through the groove. In detail, the brake disk 10 may contain sound and/or vibration due to waves generated by the friction of the brake pad in the groove. Through this, the sound and/or vibration contained in the groove may be effectively dissipated in the viscoelastic layer included in the groove.

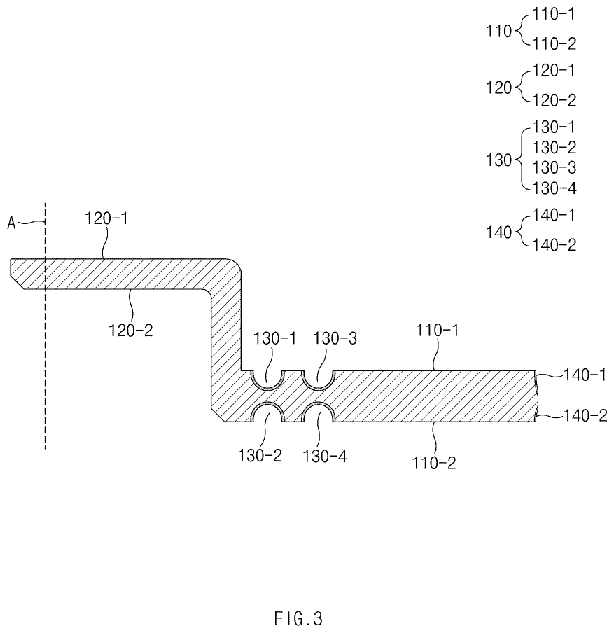

FIG. 3 is a cross-sectional view exemplarily illustrating a brake disk including a plurality of internal grooves according to an exemplary embodiment of the present disclosure.

The brake disk 10 according to various exemplary embodiments of the present disclosure may include an external portion 110 and an internal portion 120. For example, the internal portion 120 may include a first fastening surface 120-1 which may contact with the wheel, and a second fastening surface 120-2 which may contact with the hub. The external portion 110 may include a first surface 110-1 including a first brake surface that contacts with the brake pad, a second surface 110-2 including a second brake surface that contracts the brake pad, and a circumferential portion that connects the first surface 110-1 and the second surface 110-2. For reference, because the internal portion 120 and the external groove 140 illustrated in FIG. 3 may be the same as those in the description made above in FIG. 2, a description thereof may be omitted from the description of FIG. 3. Furthermore, in FIG. 3, the formation position of the internal grooves in the external portion 110 may be mainly described.

The external portion 110 may include an internal groove 130 and an external groove 140. In detail, the external portion 110 may include at least one of a (1_1)-th internal groove 130-1 and a (1_2)-th internal groove 130-3 that are formed on the first surface 110-1, a (2_1)-th internal groove 130-2 and a (2_2)-th internal groove 130-4 that are formed on the second surface 110-2, or a first external groove 140-1 and a second external groove 140-2 that are formed in the circumferential portion of the brake disk 10, or any combination thereof.

The (1_1)-th internal groove 130-1 may include a shape, in which the first surface 110-1 is recessed in a direction that faces the second surface 110-2. The (1_2)-th internal groove 130-3 may include a shape, in which the first surface 110-1 is recessed in a direction that faces the second surface 110-2. The (2_1)-th internal groove 130-2 may include a shape, in which the second surface 110-2 is recessed in a direction that faces the first surface 110-1. The (2_2)-th internal groove 130-4 may include a shape, in which the second surface 110-2 is recessed in a direction that faces the first surface 110-1.

The (1-1)-th internal groove 130-1 may include a first symmetrical shape that passes through a lower end portion of the (1-1)-th internal groove 130-1 and which is symmetrical with respect to an imaginary (1-1)-th plane which is perpendicular to the first surface 110-1. The (1-2)-th internal groove 130-3 may include a second symmetrical shape that passes through a lower end portion of the (1-2)-th internal groove 130-3 and which is symmetrical with respect to an imaginary (1-2)-th plane which is perpendicular to the first surface 110-1. The (2-1)-th internal groove 130-2 may include a third symmetrical shape that passes through a lower end portion of the (2-1)-th internal groove 130-2 and which is symmetrical with respect to an imaginary (2-1)-th plane which is perpendicular to the second surface 110-2. The (2-2)-th internal groove 130-4 may include a fourth symmetrical shape that passes through a lower end portion of the (2-2)-th internal groove 130-4 and which is symmetrical with respect to an imaginary (2-2)-th plane which is perpendicular to the second surface 110-2.

The (1_1)-th internal groove 130-1 and the (2_1)-th internal groove 130-2 may be formed in the external surface 110 to be symmetrical with respect to a plane which is perpendicular to the first surface 110-1 and the second surface 110-2. For example, the imaginary (1-1)-th plane that passes through a lower end portion of the (1_1)-th internal groove 130-1 and is perpendicular to the first surface 110-1, and the imaginary (2-1)-th plane that passes through a lower end portion of the (2_1)-th internal groove 130-2 and is perpendicular to the second surface 110-2 may be the same. In detail, when the (1_1)-th plane and the (2_1)-th plane are the same, the (1_1)-th internal groove 130-1 and the (2_1)-th internal groove 130-2 may be formed in the external portion 110 to be symmetrical to each other with respect to a plane which is perpendicular to the first surface 110-1 and the second surface 110-2. However, the (1_1)-th internal groove 130-1 and the (2_1)-th internal groove 130-2 may be formed in the external portion 110 to be asymmetrical to each other with respect to a plane which is perpendicular to the first surface 110-1 and the second surface 110-2. In detail, when the (1_1)-th plane and the (2_1)-th plane are not the same (that is, different), the (1_1)-th internal groove 130-1 and the (2_1)-th internal groove 130-2 may be formed in the external portion 110 to be asymmetrical to each other with respect to a plane which is perpendicular to the first surface 110-1 and the second surface 110-2.

The (1_2)-th internal groove 130-3 and the (2_2)-th internal groove 130-4 may be formed in the external surface 110 to be symmetrical to each other with respect to a plane which is perpendicular to the first surface 110-1 and the second surface 110-2. For example, the imaginary (1-2)-th plane that passes through a lower end portion of the (1_2)-th internal groove 130-3 and is perpendicular to the first surface 110-1, and the imaginary (2-2)-th plane that passes through a lower end portion of the (2_2)-th internal groove 130-4 and is perpendicular to the second surface 110-2 may be the same. In detail, when the (1_2)-th plane and the (2_2)-th plane are the same, the (1_2)-th internal groove 130-3 and the (2_2)-th internal groove (130-4) may be formed in the external portion 110 to be symmetrical to each other with respect to a plane which is perpendicular to the first surface 110-1 and the second surface 110-2. However, the (1-2)-th internal groove 130-3 and the (2-2)-th internal groove 130-4 may be formed in the external portion 110 to be asymmetrical to each other with respect to a plane which is perpendicular to the first surface 110-1 and the second surface 110-2. In detail, when the (1_2)-th plane and the (2_2)-th plane are not the same (that is, different), the (1_2)-th internal groove 130-3 and the (2_2)-th internal groove 130-4 may be formed in the external portion 110 to be asymmetrical to each other with respect to a plane which is perpendicular to the first surface 110-1 and the second surface 110-2.

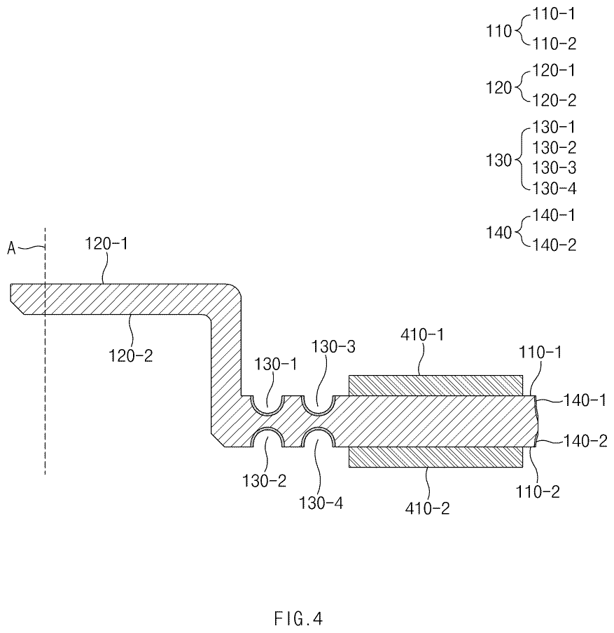

FIG. 4 is a cross-sectional view exemplarily illustrating a brake disk coupled to a plurality of internal grooves and a brake pad according to an exemplary embodiment of the present disclosure.

The brake disk 10 according to various exemplary embodiments of the present disclosure may include an external portion 110 and an internal portion 120. For example, a description of the external portion 110 and the internal portion 120 may be the same as the description described above in FIG. 2 and FIG. 3, and thus, the description thereof may be omitted in FIG. 4. Hereinafter, a description of a brake pad 410 that contacts with the brake disk 10 during braking will be made below.

The brake pad 410 that contacts with the brake disk 10 may refer to a pad which may contact with a brake surface formed on the external portion 110. For example, the brake pad 410 may include a first brake pad 410-1 and a second brake pad 410-2. The first brake pad 410-1 may contact with a first brake surface of a first surface 110-1, which is formed on the external portion 110. The second brake pad 410-2 may contact with a second brake surface of the second surface 110-2, which is formed on the external portion 110.

When the brake pad 410 and the external portion 110 contact with each other (that is, when the brake pad 410 is moved forward through a brake hydraulic pressure when the driver applies a brake pedal for braking), the brake disk 10 may reduce noise which may be generated due to waves (e.g., reflected waves) through grooves formed in the external portion 110. For example, when friction occurs between the first brake pad 410-1 and the first brake surface of the first surface 110-1, the waves generated on the first brake surface may be transmitted to the internal groove and external groove areas. The waves generated on the first brake surface may increase the number of waves and an amplitude thereof and decrease a propagation speed thereof in the internal groove and external groove areas due to the shapes of the grooves. Thereafter, the dissipated vibrational energy and an intensity of the reflected waves generated on the first brake surface may be reduced due to the viscoelastic layers included in the shapes of the grooves.

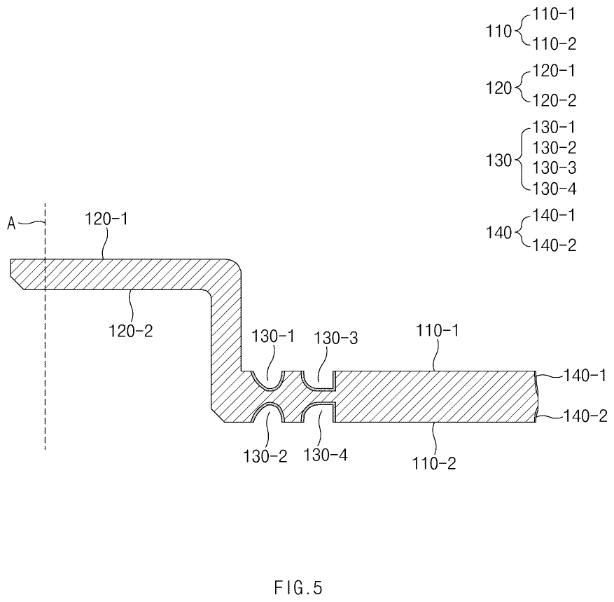

FIG. 5 is a cross-sectional view exemplarily illustrating a brake disk including an internal groove including an asymmetrical shape according to an exemplary embodiment of the present disclosure.

The brake disk 10 according to various exemplary embodiments of the present disclosure may include an external portion 110 and an internal portion 120. For example, the internal portion 120 may include a first fastening surface 120-1 which may contract the wheel, and a second fastening surface 120-2 which may contact with the hub. The external portion 110 may include a first surface 110-1 including a first brake surface that contacts with the brake pad, a second surface 110-2 including a second brake surface that contacts with the brake pad, and a circumferential portion that connects the first surface 110-1 and the second surface 110-2. For reference, a description of the internal portion 120 and the external groove 140 illustrated in FIG. 5 may be the same as the description thereof in FIG. 2 and FIG. 3, and thus, may be omitted in the description of FIG. 4. Furthermore, in FIG. 5, the features (e.g., symmetrical shape or asymmetrical shape) of the internal groove in the external portion 110 may be mainly described.

The external portion 110 may include an internal groove 130 and an external groove 140. In detail, the external portion 110 may include a (1_1)-th internal groove 130-1 and a (1_2)-th internal groove 130-3 that are formed on the first surface 110-1, a (2_1)-th internal groove 130-2 and a (2_2)-th internal groove 130-4 that are formed on the second surface 110-2, or a first external groove 140-1 and a second external groove 140-2 that are formed in the circumferential portion of the brake disk 10, or any combination thereof.

At least one internal groove may include an asymmetrical shape. For example, the (1_1)-th internal groove 130-1 may include a (1_1)-th asymmetrical shape that passes through a lower end portion of the (1_1)-th internal groove 130-1 and is asymmetrical with respect to an imaginary plane which is perpendicular to the first surface 110-1. The (1_2)-th internal groove 130-3 may include a (1_2)-th asymmetrical shape that passes through a lower end portion of the (1_2)-th internal groove 130-3 and is asymmetrical with respect to an imaginary plane which is perpendicular to the first surface 110-1. The (2_1)-th internal groove 130-2 may include a (2_1)-th asymmetrical shape that passes through a lower end portion of the (2_1)-th internal groove 130-2 and is asymmetrical with respect to an imaginary plane which is perpendicular to the second surface 110-2. The (2_2)-th internal groove 130-4 may include a (2_2)-th asymmetrical shape that passes through a lower end portion of the (2_2)-th internal groove (130-4) and is asymmetrical with respect to an imaginary plane which is perpendicular to the second surface 110-2.

At least one of the (1_1)-th asymmetrical shape, the (1_2)-th asymmetrical shape, the (2_1)-th asymmetrical shape, or the (2_2)-th asymmetrical shape, or any combination thereof may include at least two curves that are determined based on at least one of a first function for restraining a reflected wave in the brake disk 10, or a second function for cooling the brake disk 10, or any combination thereof. For example, a reflected wave which may be generated in the brake disk 10 may be generated at a time point, at which the brake surface of the external portion 110 and the brake pad rub cause friction. In detail, a first function may represent a function for determining a curve of the groove, which may minimize the reflected wave generated by the brake disk 10. Furthermore, the second function may represent a function for determining a straight line of the groove, which may minimize frictional heat generated by the brake disk 10.

For example, among the asymmetrical shapes, at least one target shape may include curves determined as a combination of a curve which may restrain or minimize the reflected wave and a curve for cooling with respect to an imaginary plane that passes through a lower end portion of the internal groove and is perpendicular to at least one of the first surface 110-1 or the second surface 110-2. In detail, the target shape may include a first sub curve which is determined based on a first function for restraining or minimizing the reflected wave and a second function for cooling the brake disk 10, and a second sub curve which is determined based on the first function and the second function and is different from the above-described first sub-curve. The first sub-curve and the second sub-curve may be included in the target shape in a form, in which they are separated with respect to an imaginary plane that passes through a lower end portion of the internal groove and is perpendicular to the first surface 110-1 (or the second surface 110-2). A detailed description of the first function and the second function will be made later in FIG. 7 below.

FIG. 6 is a view exemplarily illustrating the internal groove in the brake disk according to an exemplary embodiment of the present disclosure.

The brake disk 10 according to various exemplary embodiments of the present disclosure may include the internal groove which is formed on a surface including the brake surface that contacts with the brake pad. For example, the external portion may include a first internal groove which is formed on the first surface, a second internal groove which is formed on the second surface, or an external groove which is formed in the circumferential portion of the brake disk 10, or at least one of any combination thereof. Hereinafter, in FIG. 6, a description of a target internal groove 600 which is one of the plurality of internal grooves will be described later. For example, the target internal groove 600 may represent an internal groove including a shape, in which the first surface is recessed in a direction that faces the second surface. However, the target internal groove 600 is not limited thereto. For example, the target internal groove 600 may represent an internal groove including a shape, in which the second surface is recessed in a direction that faces the first surface.

The target internal groove 600 may include a symmetrical shape or an asymmetrical shape. For example, the symmetrical shape and the asymmetrical shape of the target internal groove 600 may be determined with respect to an imaginary plane that passes through a lower end portion of the target internal groove 600 and is perpendicular to a first parallel line V1 and a second parallel line V2. Hereinafter, the features of the symmetrical shape of the target internal groove 600 and the features of the asymmetrical shape of the internal groove 600 will be described later.

The target internal groove 600 may include a symmetrical shape which is symmetrical with respect to an imaginary plane that passes a lower end portion of the target internal groove 600 and is perpendicular to the first parallel line V1 and the second parallel line V2. For example, the symmetrical shape of the target internal groove 600 may be described based on a width 610 and a height 620. For example, the width 610 may include a first width 610-1 and a second width 610-2. The height 620 may represent a length of a line which is perpendicular to the first parallel line V1 and the second parallel line V2. The symmetrical shape of the target internal groove 600 may be the same as the first width 610-1 and the second width 610-2 with respect to the imaginary plane described above. The symmetrical shape of the target internal groove 600 may include the same curve with respect to an imaginary plane. For example, the curve included in the symmetrical shape of the target internal groove 600 may be the first curve or the second curve. In the symmetrical shape which is symmetrical with respect to the imaginary plane, when the curve which is formed on one side of the imaginary plane is the first curve, the curve which is formed on an opposite side may be the first curve. Similarly, in the symmetrical shape which is symmetrical to the imaginary plane, when the curve which is formed on one side of the imaginary plane is the second curve, the curve which is formed on the opposite side may be the second curve.

The target internal groove 600 may include an asymmetrical shape which is asymmetrical with respect to an imaginary plane that passes through a lower end portion of the target internal groove 600 and is asymmetrical with respect to the first parallel line V1 and the second parallel line V2. For example, the asymmetrical shape of the target internal groove 600 may be described based on the width 610 and the height 620. The asymmetrical shape of the target internal groove 600 may include a first width 610-1 and a second width 610-2 that are different with respect to the imaginary plane described above. The asymmetrical shape of the target internal groove 600 may include different curves with respect to an imaginary plane. For example, the asymmetrical shape of the target internal groove 600 may be at least one of a first curve, a second curve, or a straight line, or any combination thereof. In the asymmetrical shape which is symmetrical with respect to the imaginary plane, when the curve which is formed on one side of the imaginary plane is the first curve, the shape which is formed on the opposite side may be the second curve or the straight line. Similarly, in the symmetrical shape symmetrical with respect to the imaginary plane, when the curve which is formed on one side of the imaginary plane is the second curve, the shape which is formed on the opposite side may be the first curve or the straight line.

FIG. 7 is a view exemplarily illustrating the recessed shape of the internal groove in the brake disk according to an exemplary embodiment of the present disclosure.

The brake disk 10 according to various exemplary embodiments of the present disclosure may include the internal groove which is formed on the surface including the brake surface that contacts with the brake pad. Hereinafter, in FIG. 7, a description of the curve included in the target internal groove 600 which is one of the plurality of internal grooves will be made later.

The target internal groove 600 may include at least one of a first curve corresponding to a predetermined function, a second curve which is different from the first curve, or a straight line, or any combination thereof. For example, the first curve may be determined based on at least one of a first function for restraining the reflected wave in the brake disk 10, or a second function for cooling the brake disk 10, or any combination thereof.

The brake disk 10 may convert the kinetic energy of a mobility into thermal energy when there is friction between the brake pad and the external portion to decelerate the mobility. Through this, a temperature of the brake disk 10 may be increased. An increase in the temperature of the brake disk 10 may cause thermal expansion of the brake disk 10, resulting in unstable braking power or a judder phenomenon in the mobility. An increase in the temperature of the brake disk 10 may cause a fade phenomenon, in which the braking frictional force deteriorates. To prevent this, a cooling element is an essential consideration when the brake disk 10 is designed, and at the same time, an element that reduces squeal noise may also be an essential consideration.

The process of cooling the brake disk 10 may include heat transfer forms of conduction, convection, and radiation. The cooling process due to the convection phenomenon may include a phenomenon, in which a surface of the brake disk 10 (e.g., the external portion 110) is cooled while moving due to a temperature difference with ambient air, and may be expressed by Equation 4 below.

$${q}_{c} = hA Δ T \qquad [ Equation 4 ]$$

Here, q_{c} may mean a cooling heat transfer rate due to convection, h may mean a coefficient of cooling convection, “A” may mean a convection area, and ΔT may mean a temperature difference between the ambient air and the surface of the brake disk 10.

The cooling process due to the radiation phenomenon may include a phenomenon, in which atoms on the surface of the brake disk 10 are excited by heat and are cooled while electromagnetic waves are radiated to the ambient air, and may be expressed by Equation 5 below.

$${q}_{r} = εσ {AT}_{S}^{4} \qquad [ Equation 5 ]$$

Here, qᵣ may mean a cooling heat transfer rate due to radiation, ε may mean a radiative emissivity, σ may mean a Stefan-Boltzmann constant, and Tₛ may mean a surface temperature of the brake disk 10.

Based on Equations 4 and 5 described above, a cooling design of the brake disk 10 may be related to a surface area of the brake disk 10. For example, for heat influx and cooling of the brake disk 10, it may be identified based on Equations 4 and 5 that as the surface area of the brake disk 10 increases, a cooling performance of the brake disk 10 becomes higher. For example, the brake disk 10 may include a first surface 110-1 and a second surface 110-2 that are inflow portions for thermal energy due to friction, may include a first fastening surface 120-1 and a second fastening surface 120-2 that are heat conduction portions to the wheel or the hub, and may include the remaining areas in the brake disk 10, which are the cooling portions of the brake disk 10 due to convection and radiation.

The first function for restraining the reflected wave in the brake disk 10 may be explained by Equations 6 to 9 below. For example, the area formed on one side with respect to an imaginary plane that passes through a lower end portion of the target internal groove 600 and is perpendicular to the first parallel line V1 and the second parallel line V2 may be referred to as sub area 700. A curve included in the sub area 700 may be explained by the graph depicted in FIG. 7. For example, the first width 610-1 and the second width 610-2 may represent values that are set within a range, in which a rigidity of the brake disk 10 may be secured in a design stage of the brake disk 10.

To restrain reflected waves in the brake disk 10, the curve included in the target internal groove 600 (in more detail, the sub area 700) may be determined based on a power function. In detail, a power function may be used to determine the first curve. For example, the power function may be expressed by Equation 6 below.

$$y = {mx}^{n} ( n \geq 2 ) \qquad [ Equation 6 ]$$

Here, (x,y) may be included in the graph shown in FIG. 7, and (m,n) may mean a coefficient for deriving a power function.

For example, a target point (e.g., (a,b)) may represent an upper end portion of a target internal groove 600 and a point included in the sub area 700. The target point may be expressed as a position (a,b) in the graph illustrated in FIG. 7. Applying the target point to the graph depicted in FIG. 7 may be expressed by Equation 7 below.

$$b = {ma}^{n} \qquad [ Equation 7 ]$$

Here, it may mean that the target point is applied to the power function expressed in Equation 6.

The curve (e.g., the first curve) included in the sub area 700 may be determined as a curve which may be expressed by a power function. In detail, when the power function expressed in Equation 7 is a quadratic function (e.g., when n is 2), the reflected wave and/or the low frequency may be excellently restrained in the brake disk 10. Furthermore, in terms of cooling the brake disk 10, as a length of the curve included in the sub area 700 becomes larger (i.e., as the surface area becomes larger), heat convection and radiation may become dominant. In other words, the curve included in the sub area 700 may be determined by the first function for restraining the reflected wave and/or the low-frequency wave in the brake disk 10 and the second function for cooling the brake disk 10. The first function may be expressed by Equation 8 below, and the second function may be expressed by Equation 9 below.

$${L}_{1} = {\int }_{0}^{a} \sqrt{1 + {( 2 {m}_{2} x )}^{2}} dx \qquad [ Equation 8 ]$$

Here, L₁ may mean a length of a (1_1)-th curve 710 determined by the first function, and

$${\int }_{0}^{a} \sqrt{1 + {( 2 {m}_{2} x )}^{2}} dx$$

may mean a length of the curve of the first function (that is, a length of the curve of the first function depicted in the graph illustrated in FIG. 7).

$${L}_{2} = a + b \qquad [ Equation 9 ]$$

Here, L₂ may mean a length of a (1_2)-th curve 720 determined by the second function, and a+b may mean a length of a curve of the second function (i.e., the second function depicted in the graph illustrated in FIG. 7). For reference, in the specification, for convenience of description, a+b is referred to as a length of a curve, but is not limited thereto. a+b For example, L_2 or a+b may mean a length of vertical processing for maximizing a cooling performance of the brake disk 10.

$${L}_{n} = {sL}_{1} + {tL}_{2} = {\int }_{0}^{a} \sqrt{1 + {( {mnx}^{n - 1} )}^{2}} dx \qquad [ Equation 10 ]$$

Here, Lₙ may mean a length of the first curve, and sL₁+tL₂ may mean a first weight (e.g., a noise reduction weight) applied to Equation 8 and applying a second weight (e.g., a cooling weight) of the brake disk 10 applied to Equation 9. In detail, the first weight may represent a noise reduction weight and may mean a weight for reducing noise of the brake disk 10. The second weight may represent a cooling weight and may mean a weight for increasing a cooling effect of the brake disk 10. The first weight and the second weight may satisfy a predetermined interval (e.g., an interval of 0 or more and 1 or less). Furthermore, a result of adding the first weight and the second weight may satisfy a predetermined value (e.g., 1), but is not limited thereto.

Through this, the coefficient (e.g., (m,n)) for deriving the power function may be determined by Equation 7 and Equation 10. Furthermore, based on the coefficient for deriving the power function being determined, the first curve may be determined through the coefficient and target point for deriving the power function.

FIG. 8 is a view exemplarily illustrating the external groove in the brake disk according to an exemplary embodiment of the present disclosure.

The brake disk 10 according to various exemplary embodiments of the present disclosure may include an external groove which is formed in the circumferential portion. In detail, the external groove may include a shape, in which the circumferential portion is recessed in a direction that faces the rotation axis “A” of the brake disk 10. Furthermore, the external groove may typically include a first external groove 140-1 and a second external groove 140-2. Hereinafter, the external groove included in the brake disk 10 will be described later in FIG. 8.

The recessed shape of the first external groove 140-1 may include at least two curves that are determined based on at least one of the first function for restraining reflected waves in the brake disk 10, or the second function for cooling the disk, or any combination thereof. The recessed shape of the second external groove 140-2 may include at least two curves that are determined based on at least one of the first function for restraining reflected waves in the brake disk 10, or the second function for cooling the disk, or any combination thereof. The description of the first function and the second function may be the same as the description described above with reference to FIG. 7.

The circumferential portion may include a first point 810 which is commonly included in the first external groove 140-1 and the first surface 110-1, and a second point 820 which is commonly included in the second external groove 140-2 and the second surface 110-2. Furthermore, a first distance from the first point 810 to the rotation axis “A” and a second distance from the second point 820 to the rotation axis “A” may be a same or different. For example, when the first distance from the first point 810 to the rotation axis “A” and the second distance from the second point 820 to the rotation axis “A” are the same, the first external groove 140-1 and the second external groove 140-2 may be provided to be symmetrical to each other. Unlike this, when the first distance from the first point 810 to the rotation axis “A” and the second distance from the second point 820 to the rotation axis “A” are different, the first external groove 140-1 and the second external groove 140-2 may be disposed to be asymmetrical to each other.

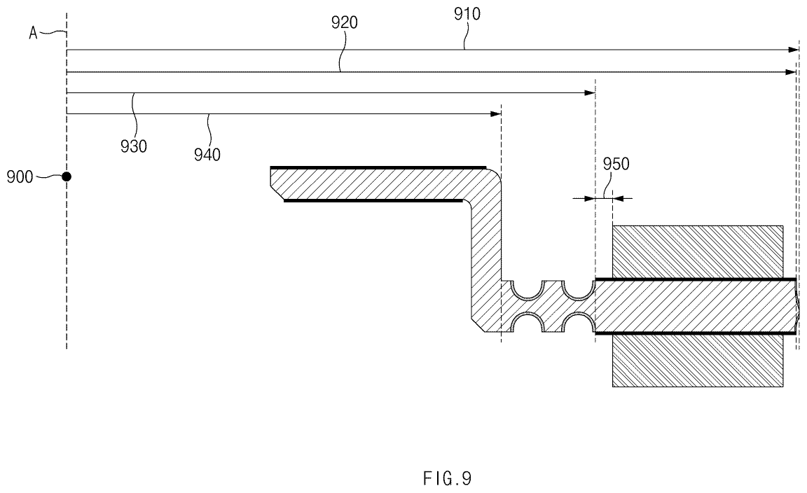

FIG. 9 is a view for illustrating formation positions of the internal groove and the external groove in the brake disk according to an exemplary embodiment of the present disclosure.

Referring to FIG. 9, FIG. 9 may illustrate positions, at which the internal groove and the external groove may be formed in the brake disk 10. For example, a distance from the rotation axis “A” to an outskirt point of the circumferential portion may be referred to as a first reference distance 910. A distance from the rotation axis “A” to the first or second point may be referred to as a second reference distance 920. A distance from the rotation axis “A” to the outskirt point of, among the internal grooves, the internal groove which is closest to the external groove may be referred to as a third reference distance 930. A distance from the rotation axis “A” to a start point of the external portion may be referred to as a fourth reference distance 940.

For example, the brake surface, on which friction between the brake pad and the brake disk 10 occurs, may be located between the second reference distance 920 and the third reference distance 930, but is not limited thereto. The first reference distance 910 may represent a total radius of the brake disk 10. The fourth reference distance 940 may represent a radius from the center portion 900 of the brake disk 10 to a point, at which a cross-sectional direction of the brake disk 10 is changed for the fastening portions of the wheel and/or the hub bearing.

The internal groove may be located between the third reference distance 930 and the fourth reference distance 940, but is not limited thereto. Furthermore, the number and the arrangement positions of the internal grooves may be determined by a designer of the brake disk 10. The external groove may be located between the first reference distance 910 and the second reference distance 920, but is not limited thereto. The distance excluding the second reference distance 920 from the first reference distance 910 may be a section, in which a chamfer of a corner of the brake disk 10 is formed to prevent side effects, such as concentration of stresses in the design of the brake disk 10. A fifth reference distance 950 may represent a clearance between a lowermost end portion of the brake pad and the brake surface, on which friction of the brake disk 10 occurs. Furthermore, the third reference distance 930 may be determined based on that the fifth reference distance 950 has been determined.

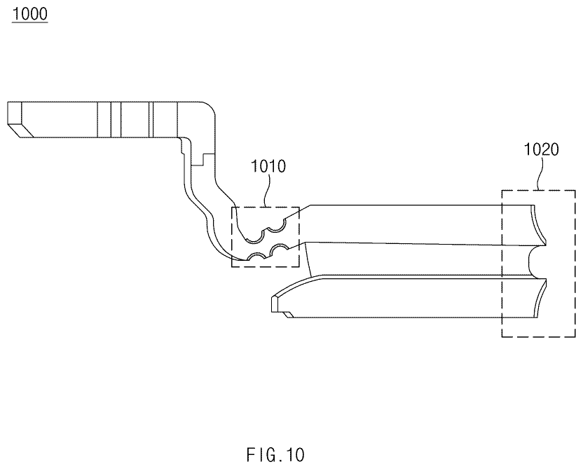

FIG. 10 is a view exemplarily illustrating a ventilated disk in the brake disk according to an exemplary embodiment of the present disclosure.

The brake disk 10 according to various exemplary embodiments of the present disclosure may include a ventilated disk 1000. For example, the ventilated disk 1000 may be a component which may be included in various mobility, and the ventilated disk 1000 may perform rotation of the ventilated disk 1000 about the rotation axis “A” when the mobility is moved on the ground. For example, the ventilated disk 1000 may include an external portion and an internal portion with respect to the rotation axis “A”.

The ventilated disk 1000 may include at least one of an internal groove 1010 of at least one ventilated disk which is formed in the external portion, or an external groove 1020 of at least one ventilated disk which is formed in the circumferential portion, or any combination thereof. For example, the circumferential portion of the ventilated disk 1000 may include a plurality of passages that are arranged in the same direction as the circumferential direction of the circumferential portion, and through which air for cooling the ventilated disk 1000 passes.

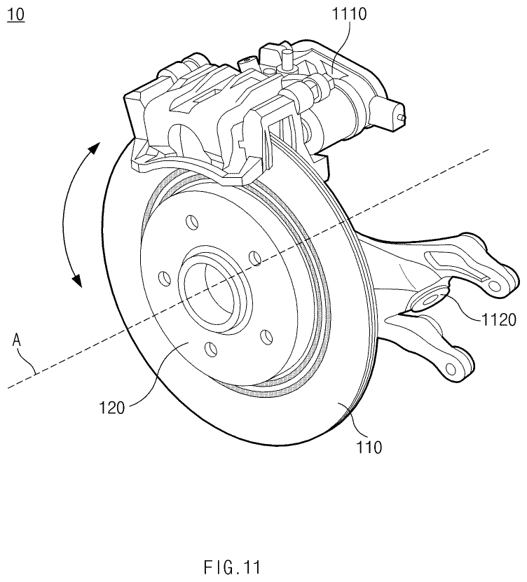

FIG. 11 is a perspective view exemplarily illustrating a brake disk coupled to a caliper and a knuckle according to an exemplary embodiment of the present disclosure.

The brake disk 10 according to various exemplary embodiments of the present disclosure may be coupled to at least one of a caliper 1110, or a knuckle 1120, or any combination thereof. The caliper 1110 may include a brake pad. The caliper 1110 may perform forward movement of the brake pad through a brake hydraulic pressure when the driver applies the brake pedal for braking. The caliper 1110 may be coupled to the external portion 110 of the brake disk 10. The knuckle 1120 may be coupled to the internal portion 120 of the brake disk 10. In detail, the knuckle 1120 may be coupled to a second fastening surface (e.g., the second fastening surface 120-1 of FIG. 1) which may contact with the hub included in the internal portion 120.

The effects of the brake disk and the method for manufacturing the brake disk according to an exemplary embodiment of the present disclosure will be referred to as follows.

According to at least one of the exemplary embodiments of the present disclosure, a brake disk including an internal groove formed on a surface including a brake surface and an external groove formed on a circumferential portion may be provided, and development costs of the brake disk may be reduced through an operation of avoiding frequencies between parts included in the brake disk and adding a damping member for reducing amplitudes to the brake disk, by providing the brake disk with the grooves each including a curve corresponding to a power function.

Furthermore, according to at least one of the exemplary embodiments of the present disclosure, squeal noise and reflected waves of the brake disk may be restrained by providing the brake disk that includes a groove formed as a curve based on a first function for restraining the reflected waves of the brake disk and a second function for cooling the brake disk.

Furthermore, various effects which may be directly or indirectly identified through the present specification may be provided.

As described above, although the exemplary embodiments have been described with reference to the limited drawings, an ordinary person skilled in the art may apply various technical modifications and variations based on this. For example, the described techniques may be performed in a different order than the described method, and/or components of the described system, structure, device, circuit, and the like may be coupled or combined in a different form than the described method, or appropriate results may be achieved even though being replaced or substituted by an equivalent.

Therefore, other implementations, other embodiments, and equivalents to the claims also fall within the scope of the claims described below.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A brake disk comprising:
an external portion including:
a first surface including a first brake surface-contacting with a brake pad;
a second surface including a second brake surface;
a circumferential portion connecting the first surface and the second surface; and
at least one of at least one first internal groove formed on the first surface, at least one second internal groove formed on the second surface, or at least one external groove formed in the circumferential portion, or any combination thereof,
wherein the at least one first internal groove includes a shape, in which the first surface is recessed in a direction facing the second surface,
wherein the at least one second internal groove includes a shape, in which the second surface is recessed in a direction facing the first surface, and
wherein the at least one external groove includes a shape, in which the circumferential portion is recessed in a direction facing a rotation axis of the brake disk.

2. The brake disk of claim 1, wherein each of the at least one first internal groove, the at least one second internal groove, and the at least one external groove includes at least one of a first curve corresponding a predetermined function, a second curve being different from the first curve, or a straight line, or any combination thereof.

3. The brake disk of claim 2, wherein the first curve is determined based on a first function for restraining a reflected wave in the brake disk.

4. The brake disk of claim 2, wherein the first curve is determined based on a second function for cooling the brake disk.

5. The brake disk of claim 1, wherein the at least one first internal groove includes:
a first symmetrical shape symmetrical with respect to an imaginary first plane passing through a lower end portion of the at least one first internal groove and being perpendicular to the first surface, and
wherein the at least one second internal groove includes a second symmetrical shape symmetrical with respect to an imaginary second plane passing through a lower end portion of the at least one second internal groove and being perpendicular to the second surface.

6. The brake disk of claim 1, wherein the imaginary first plane passing through the lower end portion of the at least one first internal groove and being perpendicular to the first surface and the imaginary second plane passing through the lower end portion of the at least one second internal groove and being perpendicular to the second plate are a same or different.

7. The brake disk of claim 1,
wherein the at least one first internal groove includes a first asymmetrical shape symmetrical with respect to an imaginary plane passing through a lower end portion of the at least one first internal groove and being perpendicular to the first surface, and
wherein the at least one second internal groove includes a second asymmetrical shape symmetrical with respect to an imaginary plane passing through a lower end portion of the at least one second internal groove and being perpendicular to the second surface.

8. The brake disk of claim 7, wherein at least one of the first asymmetrical shape or the second asymmetrical shape, or any combination thereof includes:
at least two curves determined based on a first function for restraining a reflected wave in the brake disk.

9. The brake disk of claim 7, wherein at least one of the first asymmetrical shape or the second asymmetrical shape, or any combination thereof includes:
at least two curves determined based on a second function for cooling the brake disk.

10. The brake disk of claim 1, wherein a recessed shape of the at least one external groove includes:
at least two curves determined based on a first function for restraining a reflected wave in the brake disk.

11. The brake disk of claim 1, wherein a recessed shape of the at least one external groove includes:
at least two curves determined based on a second function for cooling the brake disk.

12. The brake disk of claim 1, wherein the at least one external groove formed on the circumferential portion includes:
at least one of a first external groove recessed in a direction facing the at least one first internal groove or a second external groove recessed in a direction facing the at least one second internal groove, or any combination thereof.

13. The brake disk of claim 12, wherein the circumferential portion includes:
a first point commonly included by the first external groove and the first surface, and a second point commonly included by the second external groove and the second surface, and
wherein a first distance from the first point to the rotation axis and a second distance from the second point to the rotation axis are a same or different.

14. The brake disk of claim 1, wherein all or some of at least one of a recessed shape of the at least one first internal groove, a recessed shape of the at least one second internal groove, or a recessed shape of the at least one external groove, or any combination thereof includes:
a viscoelastic layer.

15. The brake disk of claim 14, wherein the viscoelastic layer includes:
at least one of any one of a viscoelastic layer formed of rubber or a viscoelastic layer formed of polyurethane, or any combination thereof.

16. The brake disk of claim 15, wherein the viscoelastic layer formed of the rubber includes:
a layer including adhesive, rubber, and metal.

17. The brake disk of claim 15, wherein the viscoelastic layer formed of the polyurethane includes:
a layer including adhesive, polyurethane, and nanoclay.

18. The brake disk of claim 1, wherein the circumferential portion includes:
a plurality of passages arranged in a same direction as a circumferential direction of the circumferential portion, and through which air for cooling the brake disk passes.

19. The brake disk of claim 13, wherein the brake pad includes:
a pad located based on a first reference distance being a distance from the rotation axis to an outskirt point of the circumferential portion, a second reference distance being a distance from the rotation axis to the first point or the second point, and a third reference distance being a distance from the rotation axis to an outskirt point of one of the at least one internal groove, which is adjacent to one of the at least one external groove, and
wherein the at least one first internal groove includes an internal groove located between the third reference distance and a fourth reference distance being a distance from the rotation axis to a start point of the external portion.

20. The brake disk of claim 1, wherein an interval between one of the at least one first internal groove, which is adjacent to the brake pad, and the brake pad includes a fifth reference distance.
